(19) United States
(12) Patent Application Publication
(10) Pub. No.: US 2013/0111640 A1
(43) Pub. Date: May 9, 2013

(54) Ballistic Composite Materials and Methods of Making

(71) Applicant: LINCOLN FABRICS LIMITED, St. Catherines (CA)

(72) Inventors: Andre Beth, Toronto (CA); Tulin Oktem, Toronto (CA); Randall Tatham, Anderson, SC (US)

(73) Assignee: LINCOLN FABRICS LIMITED, St. Catherines (CA)

(21) Appl. No.: 13/672,316

(22) Filed: Nov. 8, 2012

Related U.S. Application Data
(60) Provisional application No. 61/557,006, filed on Nov. 8, 2011.

(51) Int. Cl. D03D 1/00; B32B 5/02; D03D 13/00; D03D 17/00; F41H 1/00; D06M 10/00

(52) U.S. Cl. CPC D03D 1/0052; F41H 1/00; D06M 10/00; D03D 13/00; D03D 17/00; B32B 5/024
USPC 2/2.5; 28/169; 442/105; 428/221; 442/182

(57) ABSTRACT

A composite material of the present invention is comprised of a textile layer of woven fabric and a first elastomer layer disposed on a first side of the textile layer. The textile layer may comprise a compound fabric such as a double-layer fabric. The double-layer fabric may have a first layer woven as a plain weave and a second layer woven as a crowfoot weave (3/1 twill weave). The composite material may further comprise a second elastomer layer disposed on the second side of the textile layer. The present invention may be embodied as a method of manufacturing a composite material comprising the steps of coating a compound fabric with an elastomer material and allowing the elastomer material of the coating to cure.

### CROSS-REFERENCE TO RELATED APPLICATIONS

The present application claims the benefit of U.S. Provisional Patent Application No. 61/557,006, filed on Nov. 8, 2011, and titled “Ballistic Composite Material and Method of Making,” which application is incorporated herein by reference in its entirety.

### FIELD OF THE INVENTION

The present invention relates to the field of ballistic materials and methods for making same.

### BACKGROUND OF THE INVENTION

Designers of bullet-resistant vests (“ballistic vests”) have long struggled with the conflicting priorities of increased bullet resistance and increased comfort and mobility of the wearer. Effective ballistic vests must be manufactured from a material that meets a minimum performance threshold for resistance to ballistic projectiles. Through the years, woven goods have not only provided the necessary ballistic protection, but also have encouraged users to wear the vests due to the relative comfort from the flexibility and reasonable weight. Recent changes in ballistic resistance standards, for example, National Institute of Justice (“NIJ”) Standard 0101.06, titled “Ballistic Resistance of Body Armor,” have created significant new limitations on vest performance. In particular, toughened standards on the “backface signature”—deformation of the wearer-side of a vest caused by the impact of a projectile—have caused vest designers to limit the quantity of woven fabrics formerly used in these garments. Stiffer materials, such as laminated, unidirectional, and/or non-woven materials have displaced up to 50% of the woven goods used in current vests. This changed has drastically reduced the comfort of the vests.

Para-aramid materials, such as Twaron® and Kevlar®, are currently the leading fibers due to their excellent mechanical performance and acceptable stability. Kevlar is spun into fibers, and weaving the fibers (or bundles of Kevlar fibers—“yarns”) causes an impacting bullet to stretch the fibers in order to penetrate. The bullet-stopping power is primarily due to the large amount of energy required to stretch a molecule of Kevlar. Therefore, a bullet's kinetic energy is absorbed in stretching (and breaking) the Kevlar fibers upon impact. Energy is also radially dissipated (radiating through the fabric layer from the point of impact) through the weave structure.

Composite materials using aramid fibers combined with vibration dampening substances are known in the art. U.S. Patent Application Publication 2009/0075026, to Vito et al., (the “'026 Application”) discloses a composite material made by using an aramid fiber weave disposed between two elastomeric layers. Such technologies have been used successfully to reduce the effects of a non-ballistic impact of an object by absorbing mechanical vibrational energy in the first (outermost) elastomeric material, and redirecting vibrational energy and providing stiffness in the fibrous material layer. In ballistic resistant applications, however, an outer elastomer layer will have little effect in absorbing the kinetic energy of a bullet. The '026 Application teaches the use of one or more generally rigid plates of rigid materials to distribute the impact force over an increased amount of the composite material. Such a composite with rigid plates is taught as useful in using the material in, for example, bulletproof vests. As such, designs of ballistic vests with composite materials include the use of stiffer, rigid materials in response to the backface signature standards of NIJ 0101.06. However, the usability and comfort of the wearer is affected by such composites due to the stiffness of the fibrous material layer and generally rigid plates.

Textiles used in ballistic resistant materials may be configured in weave patterns which have ballistic resistant qualities. Specifically, the weave pattern should be resistant to penetration of a ballistic projectile by causing the energy to be transformed into stretching and/or breaking fibers. This is best performed when the weave is capable of maintaining its configuration without, for example, spreading yarns apart to allow passage of the projectile without sufficient energy transferred into stretching fibers (or conversely being forced together by a passing projectile). A primary technique previously used to maintain the configuration of a weave is to create a textile with a tight weave (i.e., having low air permeability). However, such a tight weave typically increases the stiffness of the fabric—negatively impacting usability and comfort.

Accordingly, there is a need for an improved ballistic material which reduces rigidity while enhancing the ballistic resistance by, for example, reducing the backface signature of an impacting projectile.

### BRIEF SUMMARY OF THE INVENTION

A composite material of the present invention is comprised of a textile layer of woven fabric and a first elastomer layer disposed on a first side of the textile layer. The textile layer may comprise a compound fabric such as a double-layer fabric. The double-layer fabric may have a first layer woven as a plain weave and a second layer woven as a crowfoot weave (3/1 twill weave). The composite material may further comprise a second elastomer layer disposed on the second side of the textile layer.

The present invention may be embodied as a method of manufacturing a composite material comprising the steps of coating a compound fabric with an elastomer material and allowing the elastomer material of the coating to cure.

### DESCRIPTION OF THE DRAWINGS

For a fuller understanding of the nature and objects of the invention, reference should be made to the following detailed description taken in conjunction with the accompanying drawings, in which:

FIG. 1A depicts a cross-sectional diagram of a material having a double-layer compound fabric according to an embodiment of the present;

FIG. 1B depicts a cross-sectional diagram of a material having a triple-layer compound fabric according to another embodiment of the present;

FIG. 2 depicts the weave structures of two fabrics, a plain weave and a crowfoot weave, suitable for use in embodiments of the present invention;

FIG. 3 is another view of the two fabrics of FIG. 2;

FIG. 4 depicts a double-layer fabric for use in an embodiment of the present invention;

FIG. 5 is another view of the double-layer fabric of FIG. 4;

FIG. 6 is another view of the double-layer fabric of FIGS. 4 and 5;

FIG. 7 depicts the structure of two fabrics, a plain weave and a crowfoot weave, suitable for use in embodiments of the present invention, wherein the yarns of the fabrics are thicker than those used in other embodiments;

FIG. 8 is another view of the two fabrics of FIG. 7;

FIG. 9 depicts a double-layer fabric for use in another embodiment of the present invention, wherein the yarns of the fabrics are thicker than those used in other embodiments;

FIG. 10 is another view of the double-layer fabric of FIG. 9;

FIG. 11 is another view of the double-layer fabric of FIGS. 9 and 10; and

FIG. 12 is a flowchart showing a method according to another embodiment of the present invention.

### DETAILED DESCRIPTION OF THE INVENTION

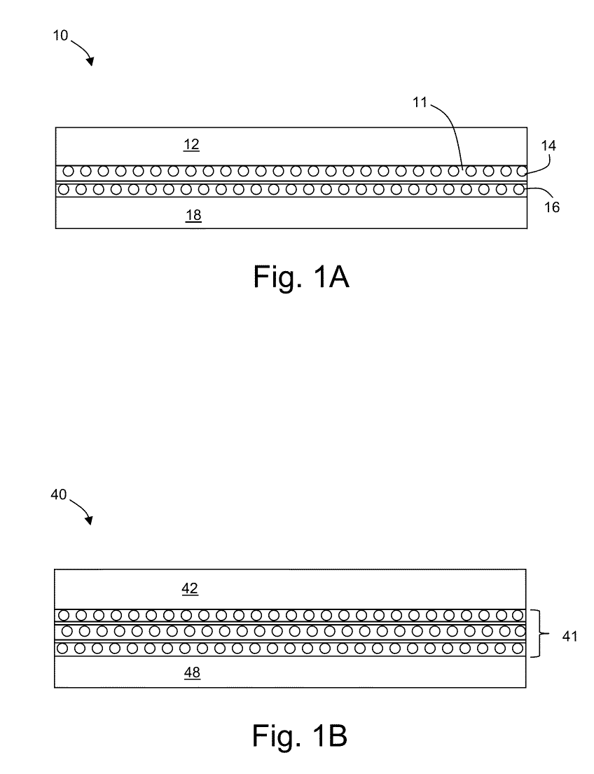

The present invention may be embodied as a composite material 10 comprising a woven fiber layer (“textile” layer). The textile layer may preferably be a compound fabric layer 11 woven from a plurality of warp and weft yarns. As used herein, a compound fabric is a fabric having more than one interlaced layer of woven fabric (further described below). FIGS. 1A and 1B depict exemplary embodiments of materials 10, 40 according to the present invention having a double-layer fabric 11 (FIG. 1A) and a triple-layer fabric 41 (FIG. 1B). The yarns of the fabric are assembled from a plurality of fibers—multifilament yarns. The fiber may be an aramid fiber. More specifically, the fiber may be a para-aramid, such as, for example, Kevlar® brand fiber. The yarns may be of any linear density, and preferably from approximately 200 denier to 3,000 denier.

The composite material 10 of the present invention further comprises a first elastomer layer 12 disposed on a first side of the compound fabric layer 11. As such the elastomer layer 12 may be described as a coating on the compound fabric layer 11. The elastomer layer 11 may be disposed on the compound fabric layer 11 such that a portion of the material forming the elastomer layer 11 impregnates at least a portion of the weave of the compound fabric layer 11. The elastomer layer 12 may function to hold the weave configuration of the compound fabric layer 11 together near the point of impact of a ballistic object (e.g., a bullet) and throughout a radial distance from the point of impact. The elastomer layer 12 may act as a shock absorber between yarns of the weave, absorbing the tendency to of the yarns to move relative to each other. In this way, the kinetic energy of the movement of yarns is transferred into heat energy by the elastic property of the elastomer used in the elastomer layer 12. Where the extent of the elasticity of the elastomer is reached, energy may be absorbed by the localized tearing (failure) of the elastomer.

The elastomer coating 12 may be formed from any elastomer. For example, the elastomer may be urethane rubber, silicone rubber, nitrile rubber, butyl rubber, acrylic rubber, natural rubber, styrene-butadiene rubber, and the like. In general, any elastomer material can be used to form the first elastomer layer without departing from the scope of the present invention. For example the elastomer layer may be a thermoset elastomer layer. Alternatively, the elastomer layer 12 can be a thermoplastic or any material suitable for thermoforming. An interface layer may be used between the elastomer layer 12 and the compound fabric layer 11. Such an interface layer improves the bond between the chosen elastomer and the fibers of the fabric. The interface layer may be, for example, an adhesive or a primer. The elastomer used in the elastomer layer 12 may require a drying or curing operation step during manufacturing, depending on the chosen elastomer.

A second layer 18 of elastomer may be disposed on a second side of the compound fabric layer 11 (opposite the first side of the compound fabric layer 11). Similar to the first elastomer layer 12, described above, the second elastomer layer 18 may be constructed from any elastomer. The elastomer of the second elastomer layer 18 may be the same elastomer as that of the first elastomer layer 12. The elastomer of the second elastomer layer 18 may be different than that of the first elastomer layer 12.

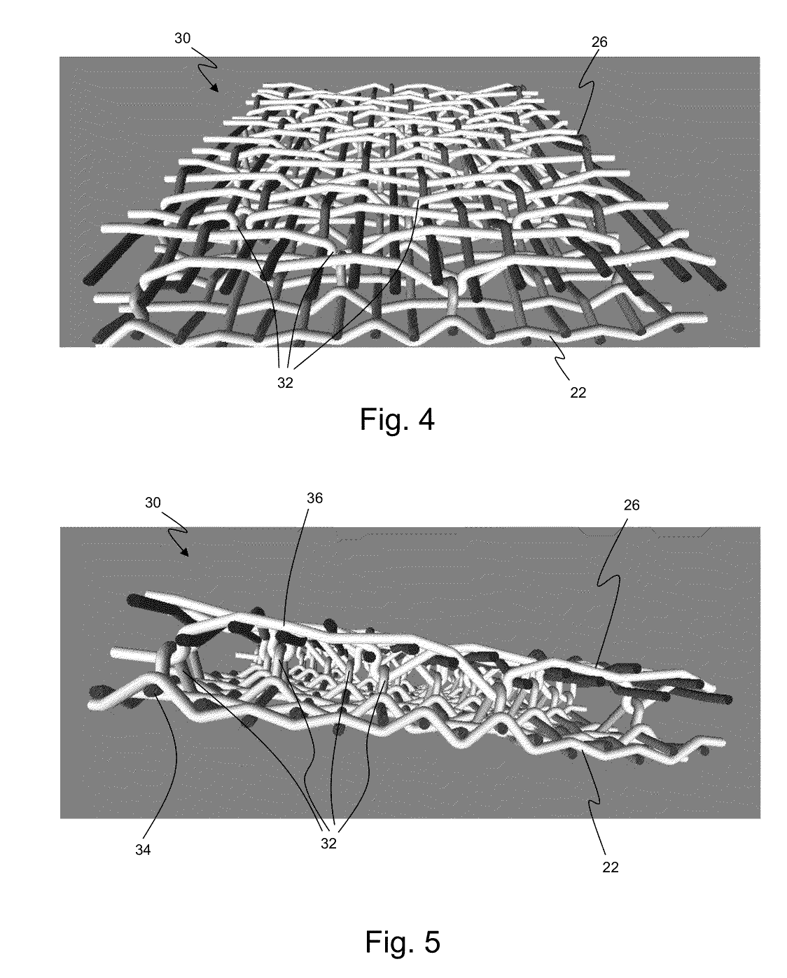

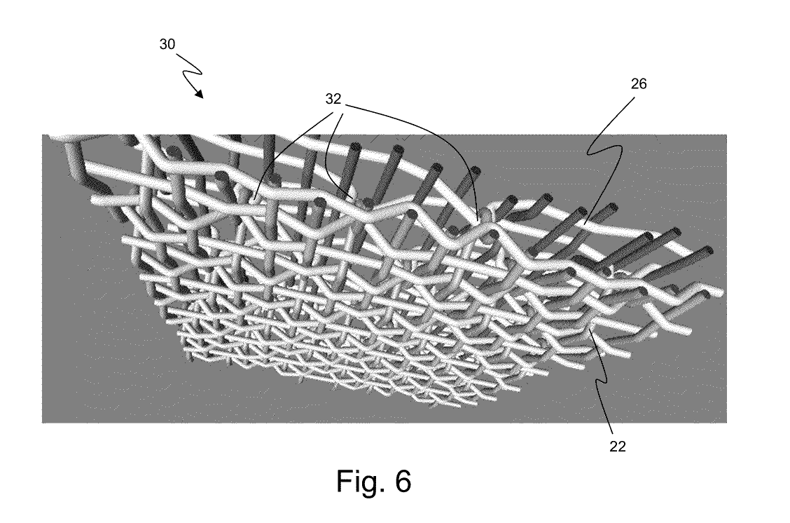

An embodiment of a composite material 10 according to the present invention is depicted in FIG. 1A. The composite material 10 comprises a first elastomer layer 12 and a second elastomer layer 18. The compound fabric layer 11 of the depicted embodiment is a double-layer fabric comprising a first layer 14 and a second layer 16. The double-layer fabric may be a plain weave 22 fabric tied to a crowfoot weave 26 (3/1 twill weave) using a plurality of the yarns of one or both weaves 22, 26 to connect (tie) the weaves 22, 26 together into a single, compound (double-layer) fabric. FIGS. 4-6 depict an example of such a double-layer fabric 30. The double-layer fabric 30 may be constructed of the two layers of fabric 22, 26 tacked together by tack points 32 formed by picking certain warp yarns 34 of one layer with certain weft yarns 36 of the other layer.

The first and/or second elastomer layers 12, 18 may be made from elastomers which are foamed—e.g., elastomer materials incorporating a plurality of gas bubbles within the material. In some embodiments, the elastomer of the elastomer layers 12, 18 may comprise a chemical blowing agent which causes foaming upon certain conditions as is known in the art.

In testing, the performance of rubber (elastomer)-coated fabrics has been shown to be enhanced by use of a compound fabric layer 11, and further enhanced using certain weave patterns within the fabric. For example, a double-layer fabric (a fabric having a first layer and a second layer) may comprise two plain weave layers. In another embodiment, depicted in FIGS. 4-6, the double-layer fabric comprises a plain weave layer 22 and a twill weave layer, such as, for example, a crowfoot weave layer 26 (e.g., a 3/1 twill weave). In testing composite materials made according to the present invention, such crowfoot weaves 26 have been shown to perform better than other weaves. Compound fabric layers 11 made from double- and triple-layer fabrics according to the present disclosure have been shown to enhance the performance of rubber (elastomer)-coated fabrics. The weaves according to the present invention may also comprise additional layers (e.g., more than three).

In a multi-layer fabric, the structure of one woven layer is considered to enhance the integrity of another layer. As such, one layer may be thought of as holding the other layer together. This effect may be even more synergistic where the weave structures of the layers are not the same. For example, a plain weave may “open up” (spread apart upon impact of a projectile) in a characteristic way (along force vectors) which is different from the way in which a twill weave opens up. By combining, for example, two different weaves into a double-layer fabric, the integrity of the weave structure of each layer may be increased without adding a significant amount of rigidity.

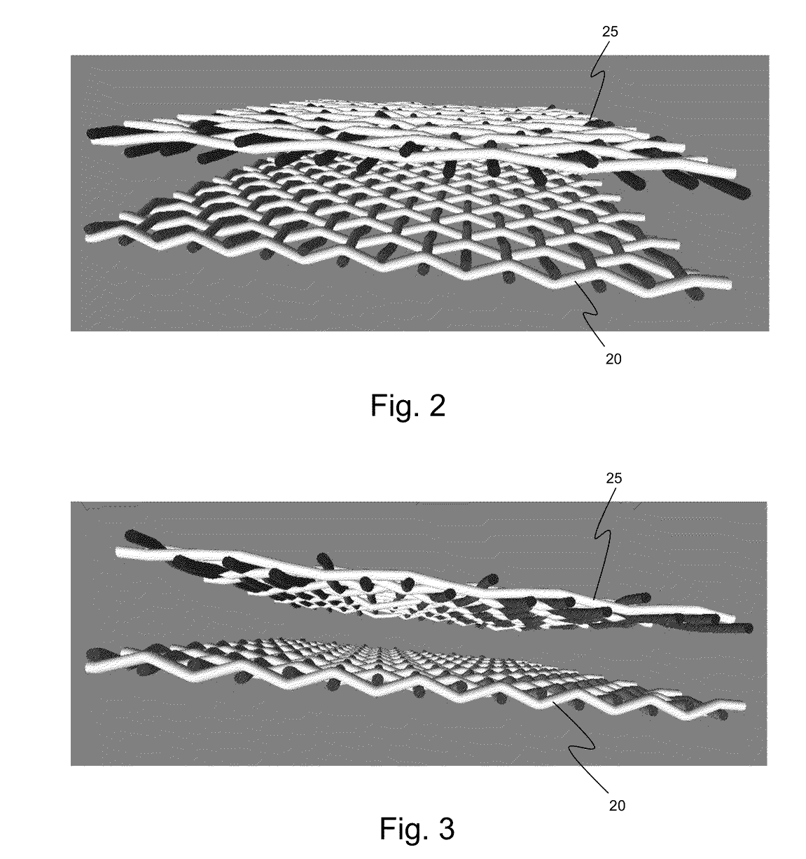

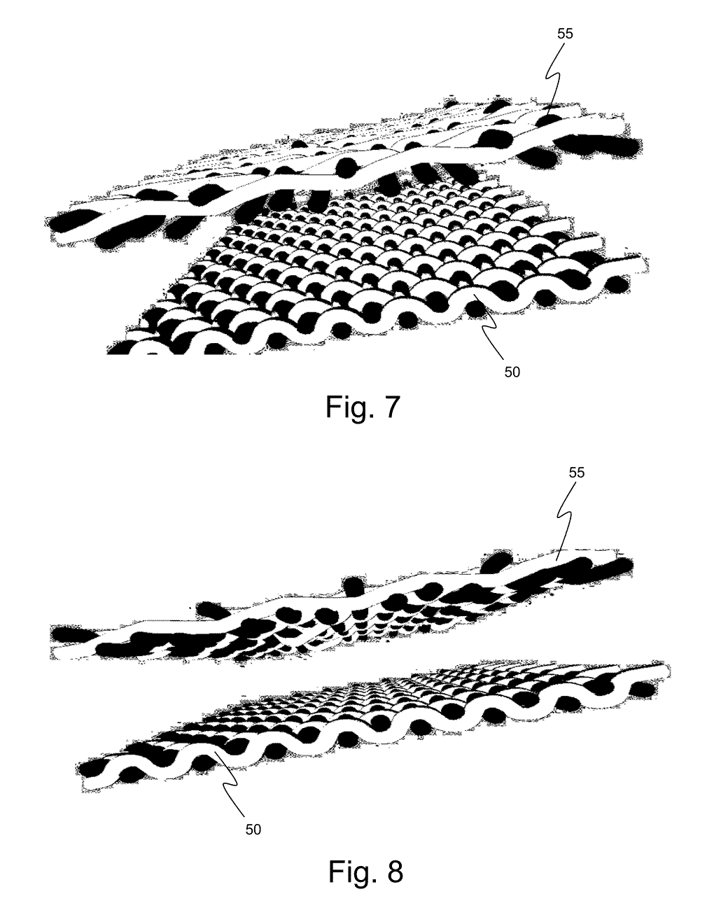

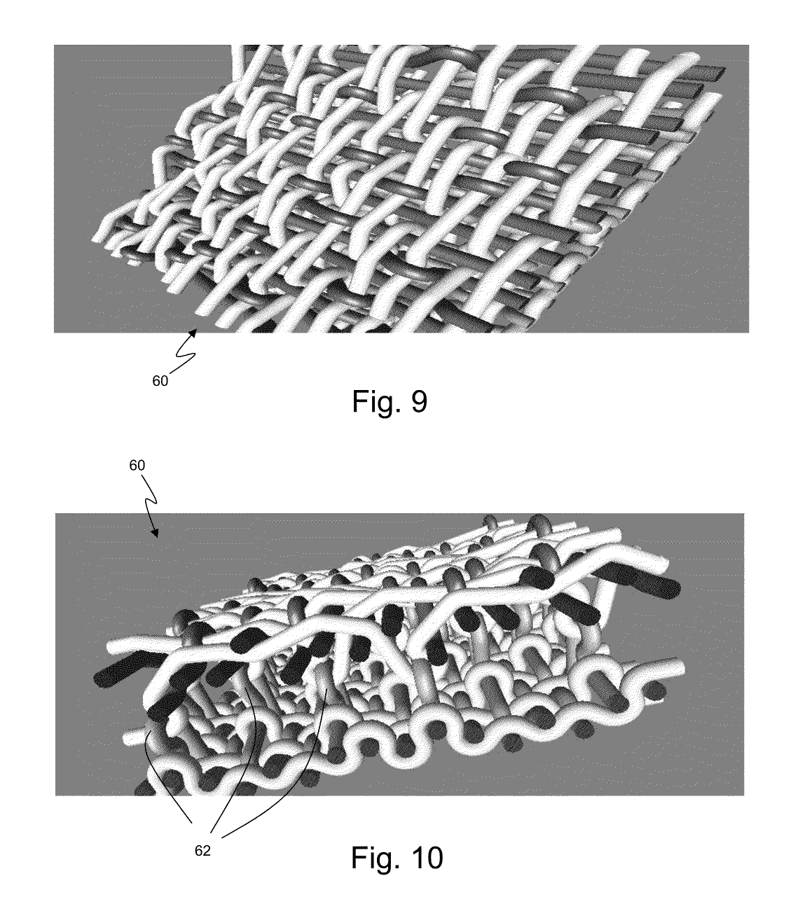

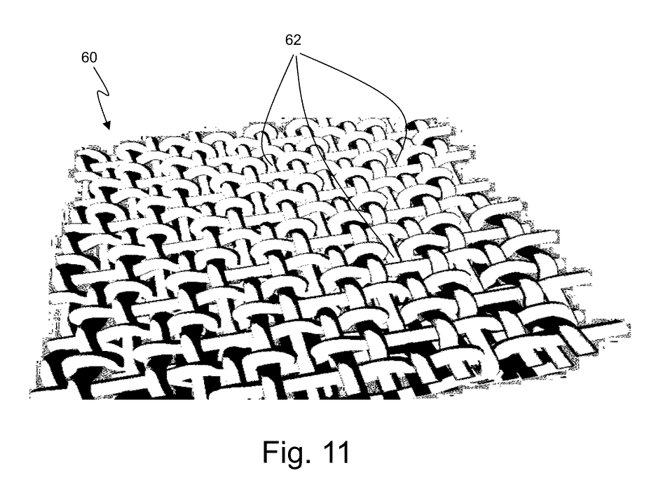

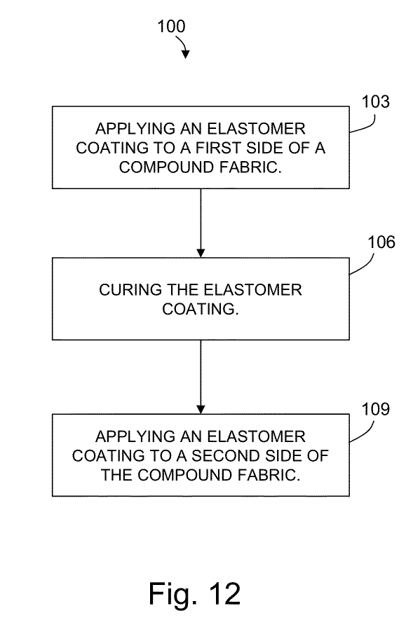

FIGS. 7-8 depict two fabrics—plain weave 50 and crowfoot weave 55—which comprise yarns thicker than those used in the fabrics of FIGS. 2-3 (e.g., having a higher denier value). FIGS. 9-11 depict the formation of a double-layer fabric 60 used in another embodiment of a material according to the present invention using the thicker yarns. The number of tack points 62 is greater than the number used in embodiments using “thinner” yarns.

Composite materials of the present invention may be used to manufacture garments according to another embodiment of the present invention. The garments may be, for example, vests, jackets, pads, braces, etc. The materials may also be used to enhance objects such as cars, briefcases, backpacks, etc.

The present invention may be embodied as a method 100 of manufacturing a composite material such as those materials described above. The method 100 comprises the step of applying 103 an elastomer coating to a first side of a compound fabric. The elastomer coating may be applied 103 in any way known in the art, such as, for example, spraying, rolling, pouring, spreading, brushing, or any combination of techniques. For example, the elastomer may be poured on to the compound fabric and the spread using a squeegee-type device. Such techniques may also cause the elastomer material to impregnate the fabric.

The method 100 comprises the step of curing 106 the elastomer coating. Curing 106 may be accomplished by, for example, simply allowing time for the elastomer material to cure (e.g., cross-link). Curing 106 may be accomplished using other common techniques, including, for example, heating the elastomer. In this way, curing 106 the elastomer coating may be accomplished by passing the composite material (with elastomer in an uncured state), through a heater, such as an oven.

The method 100 may comprise the step of applying 109 an elastomer coating to the second side of the compound fabric. This step of applying 109 to the second side may be accomplished before or after curing 106 the elastomer coating of the first side.

In another embodiment of a method of manufacturing, an elastomer may be provided in sheet form (such as on a roll). In this way, manufacturing a composite material comprises bonding a sheet of elastomer material to a compound fabric. Bonding may be accomplished using an interface, such as an adhesive, by heating the elastomer sheet, or by other techniques known in the art.

Although the present invention has been described with respect to one or more particular embodiments, it will be understood that these embodiments are intended to be exemplary and that other embodiments of the present invention may be made without departing from the spirit and scope of the present invention.

We claim:

1. A composite material for use in ballistic applications, comprising:
a compound fabric layer having a first side and a second side; and
a first elastomer layer disposed on the first side of the compound fabric layer.

2. The composite material of claim 1, wherein the compound fabric layer comprises a double-layer fabric.

3. The composite material of claim 2, wherein a first layer of the double-layer fabric is connected with a second layer of the double-layer fabric using a plurality of yarns from one or both weaves.

4. The composite material of claim 2, wherein each layer of the double-layer fabric is a plain weave.

5. The composite material of claim 2, wherein a first layer of the double-layer fabric is a plain weave and a second layer of the double-layer fabric is a crowfoot weave.

6. The composite material of claim 5, wherein the crowfoot weave is a 3/1 twill weave.

7. The composite material of claim 1, wherein the compound fabric layer comprises a triple-layer fabric.

8. The composite material of claim 7, wherein at least one layer of the triple-layer fabric is a crowfoot weave.

9. The composite material of claim 7, wherein at least one layer of the triple-layer fabric is a crowfoot weave, and at least one other layer of the triple-layer fabric is a plain weave.

10. The composite material of claim 1, wherein the compound fabric layer comprises a multi-layer fabric having more than three layers.

11. The composite material of claim 1, wherein the compound fabric layer is woven from yarns having a linear density from 200 denier to 3,000 denier.

12. The composite material of claim 7, wherein the yarns comprise a plurality of aramid fibers.

13. The composite material of claim 1, wherein the first elastomer layer comprises an elastomer selected from the group consisting of urethane rubber, silicone rubber, nitrile rubber, butyl rubber, acrylic rubber, natural rubber, styrene-butadiene rubber.

14. The composite material of claim 1, wherein the first elastomer layer comprises a foamed elastomer.

15. The composite material of claim 1, further comprising a second elastomer layer disposed on the second side of the compound fabric layer.

16. The composite material of claim 1, further comprised an interface layer disposed between the compound fabric layer and the elastomer layer for enhancing the bond between the compound fabric layer and the elastomer layer.

17. An apparatus comprising:
a garment made from a composite material, the composite material comprising:
a compound fabric layer having a first side and a second side; and
a first elastomer layer disposed on the first side of the compound fabric layer.

18. The apparatus of claim 17, wherein the garment is a vest.

19. A method of making a composite material, comprising the steps of:
applying an elastomer coating to a first side of a compound fabric; and
curing the elastomer.

20. The method of claim 19, wherein the elastomer is applied by spraying, rolling, pouring, spreading, brushing, or a combination of more than one of these.

21. The method of claim 19, wherein the elastomer comprises a chemical blowing agent.

22. The method of claim 19, wherein the step of curing the elastomer further comprises the substep of heating the elastomer coating.

23. The method of claim 19, further comprising the step of applying an elastomer coating to a second side of the compound fabric.
